(19) United States
(12) Patent Application Publication
(10) Pub. No.: US 2020/0054034 A1
(43) Pub. Date: Feb. 20, 2020

(54) PROCESS, APPARATUS AND SYSTEM FOR TREATING FRUITS OR VEGETABLES

(71) Applicant: Naturo Innovations Pty Ltd, Coolum Beach (AU)

(72) Inventor: Jeffrey John HASTINGS, Queensland (AU)

(21) Appl. No.: 16/663,480

(22) Filed: Oct. 25, 2019

Related U.S. Application Data
(62) Division of application No. 15/303,462, filed on Oct. 11, 2016, now abandoned.

(30) Foreign Application Priority Data
Apr. 11, 2014 (AU) 2014901332

(51) Int. Cl. A23B 7/06; A23B 7/04; A23N 12/04

(52) U.S. Cl. CPC A23B 7/06; A23B 7/04; B65B 25/041; A23V 2002/00; A23N 12/04

(57) ABSTRACT

An apparatus for blanching segmented avocados uses a conveyor system for transporting the avocados from one end of a blanching chamber to an opposite end, the conveyor system having a perforated conveyor belt positioned on two or more drive rollers for transporting the avocados into and out of the blanching chamber and driven by a drive mechanism. The blanching chamber includes a shroud overlying the conveyor belt and in longitudinal alignment in relation thereto to at least partially enclose steam produced from a bath underlying the conveyor belt and in longitudinal alignment with the shroud and the conveyor belt. During use, the steam is at least partially enclosed by the shroud thereby exposing the segmented avocados positioned on the perforated conveyor belt to steam and blanching the avocados in the blanching chamber at a blanching pressure, at least a portion of which is not sealed from atmosphere.

### TECHNICAL FIELD

This invention relates to a process, system and apparatus for treating cut fruits or vegetables such as Avocados that are susceptible to browning or discolouration even during refrigeration.

### BACKGROUND ART

Some fruits and vegetables such as the avocado present unique challenges to the food industry. Avocados are particularly unusual because they are highly susceptible to chilling injury. If they are stored at refrigeration temperatures for very long they will discolour and develop off-flavours. Whilst many people throughout the world enjoy eating avocados, difficulties in storing sliced avocado, and the rapid degradation of their desirable organoleptic traits once they are cut, implies that they are not widely used in shelf stable foods. Instead, avocados are largely consumed when freshly cut such as in salads, in sushi, on sandwiches, in guacamole, or simply sliced. Moreover, the known food treatment methods that render most other fruits and vegetables stable further degrades the avocados at an undesirable state. Unless avocados are immediately consumed after slicing, they are difficult to use because their flavour and colour degrades rapidly. This is true whether or not the sliced avocado is maintained at room temperature or at refrigeration temperature.

Conventional food preservation methods that use heat and pressure tend to activate the native enzymes in the avocado and undesirably affect texture, taste, and appearance of an avocado and likely negatively affect the avocado. Avocados have a high fat content and also contain large amounts of degradative enzymes such as lipases, lipoxygenases, polyphenoloxidase, and methyl pectinases. Once an avocado is sliced the enzymes are released. The enzymes are then able to act upon the fat and other components of the fruit. The enzymes, in particular the lipases, degrade the fats and thus off flavours including rancidity are developed. These enzymes are also responsible for discolouration or browning of the fruit. This browning at least in part is caused due to an enzyme called polyphenoloxidase which is also present in mushrooms, apricots, pears, cherries, peaches, and dates. The polyphenoloxidase (PPO) oxidizes phenolic compounds in the pulp tissue of a fruit and causes condensation to form brown or grey polymers. Whilst in a whole fruit this is not a problem bruising or slicing disrupt cells in the pulp as a result of which the enzymes and the phenolic compounds come into contact with each other and react to form the dark pigments.

Air also acts to degrade the appearance and the flavour of avocados. The beautiful bright green colour characteristic of a ripe and freshly cut avocado is from the chlorophyll present in the fruit. However, Magnesium in chlorophyll is oxidized upon exposure to the air. Once oxidized, the chlorophyll changes colour from a vibrant green to a brownish green colour. Once again this change of colour is less appetizing in appearance than the bright green of a freshly sliced avocado.

Therefore, in view of the above shortcomings there has been a long felt need for treating fruits and vegetables such as avocados in a manner that preserves the colour and flavour of fruits such as avocados even after the avocados are sliced, or in the case of guacamole preparation, even after the avocados are macerated.

The reference to any background information in this specification is not, and should not be taken as an acknowledgement or any form of suggestion that the prior art forms part of the common general knowledge.

### SUMMARY OF INVENTION

In one aspect, the invention provides a process for treating fruits or vegetables for minimize browning upon subsequent processing, handling, and storage, the method comprising:

(a) separating edible pulp tissue from inedible tissue of the fruit or vegetable;

(b) blanching said edible pulp tissue in steam for a pre-determined blanching time period at a blanching pressure that is less than or equal to atmospheric pressure, the blanching time period being less than a cooking time period required to cook the edible pulp tissue;

(c) cooling the blanched pulp tissue and extracting residual heat from the blanched pulp tissue; and

(d) freezing the cooled pulp tissue to obtain at least partially frozen pulp issue;

wherein the frozen pulp tissue obtained from step (d) possesses substantially similar organoleptic properties as freshly separated pulp tissue in (a).

Preferably, the blanching time period is less than a cooking time period required to cook the edible pulp tissue.

As should be relatively clear, the blanching step will preferably take place without directly contacting edible pulp tissue with water by immersion.

Preferably, a pre-determined volume of steam is used for the said blanching step (b) for a pre-determined volume of edible pulp tissue.

The steam may circulate about the edible pulp tissue via natural or forced convection currents. Forced convection will typically require a circulation device such as a fan or blower.

In an embodiment, the process further comprises an additional step of inducing turbulent flow to the steam in the blanching step (b).

In an embodiment, the process comprises transporting the separated edible tissue on a conveyor apparatus to a blanching chamber for carrying out the blanching step (b). The separated edible tissue is positioned on an endless conveyor belt driven by a conveyor drive mechanism. As a result, the separated edible pulp tissue is passed into the blanching chamber and thereby conveyed in and out of the blanching chamber.

The operating speed (Cs) of the conveyor belt driven by the drive mechanism may be varied by a control system for controlling a rate of passage of the edible tissue through the blanching chamber.

In an embodiment, the freezing step (d) comprises rapid freezing of at least an outer surface of the edible tissue.

In an embodiment, after the cooling step, the cooled and blanched pulp tissue is positioned on a freezing conveyor belt driven by a freezing conveyor drive and passed into a freezing chamber for carrying out the freezing step (d) and for passing the frozen pulp tissue obtained from step (c) out of the freezing chamber. An operating speed (CF) of the freezing conveyor belt driven by the freezing conveyor drive may be varied for controlling a rate of passing the blanched tissue into the freezing chamber.

In an embodiment, the blanching step (b) is preceded by a segmenting step in which the separated edible tissue from step (a) is segmented into discrete pieces. Preferably, the segmenting is carried out by slicing the edible pulp tissue into the discrete pieces.

The blanching time period may be in the range of 1-10 minutes, preferably 2-6 minutes and more preferably 3-5 minutes.

Preferably, the freezing step (d) is carried out for a freezing time period in the range of 2-6 minutes and more preferably 3-5 minutes. In alternative embodiments the freezing step may also be carried out for longer time periods in excess of 6 minutes.

Preferably the fruit or vegetable is a fresh fruit or vegetable in that the fruit or vegetable has not undergone a freezing process after picking. A preferred fruit is Avocado.

In another aspect, the invention provides an apparatus for blanching segmented fruits or vegetables, the apparatus comprising:

a conveyor system for transporting said fruits or vegetables from one end of a blanching chamber to an opposite end, the conveyor system comprising a conveyor belt positioned on two or more drive rollers for transporting said fruits or vegetables and adapted to be driven by a drive mechanism;

the blanching chamber comprising a shroud overlying the conveyor belt and in longitudinal alignment in relation to the conveyor belt to at least partially enclose steam produced from water in a bath positioned underlying the conveyor belt and in longitudinal alignment with the shroud and the conveyor belt;

wherein during use the steam produced in the bath is at least partially enclosed by the shroud thereby exposing the segmented fruits or vegetables positioned on the conveyor belt to steam and blanching the fruits and vegetables in the blanching chamber at a blanching pressure that is less than or equal to atmospheric pressure.

Preferably, the conveyor belt is adapted for allowing passage of steam therethrough from an underside in use position of the conveyor belt to an in use fruit or vegetable supporting surface of the belt. The conveyor belt may comprise perforations for passage of steam therethrough.

In an embodiment, the apparatus further comprises a control system for varying an in use belt speed of the conveyor belt thereby varying blanching time period of the fruits and vegetables in the blanching chamber. Preferably, the control system is adapted to vary the in use belt speed with reference to one or more parameters relating to the segmented fruits and vegetable positioned on the conveyor belt during use. The control system may also be sufficiently adapted to prevent the in use belt speed from being below a pre-determined value of belt speed.

In an embodiment, the apparatus further comprises a steam control mechanism for controlling steam volume, steam pressure and/or steam temperature.

In yet another aspect, the invention provides a system for treating segmented fruits or vegetables upon, the system comprising the apparatus for blanching as described in the preceding sections and further comprising a cooling apparatus positioned for receiving and extracting heat from the blanched fruits or vegetables and a freezing apparatus for receiving the cooled fruits or vegetables for at least partially freezing the segmented fruits or vegetables.

Without wishing to be bound by theory, it is hypothesized that blanching of the segmented fruits or vegetables for a designated time period as described in the aforementioned sections assists in inhibiting the reaction between PPO and the phenolic compounds present in the edible tissue thereby preventing or at least reducing the extent of browning in the edible tissue. It is also hypothesized that cooling and subsequent freezing of the blanched edible tissue after a designated or threshold time period assists in preventing the initial blanching progressing to complete cooking of the edible pulp tissue while at the same time helps in retaining the browning minimisation effect imparted by the blanching.

Preferably, the conveyor system transports blanched fruits or vegetables to the cooling apparatus and subsequent to the extraction of heat further transports the cooled fruits or vegetables to the freezing apparatus.

In an embodiment, the system further comprises a fruit segmenting apparatus for separating edible tissue from inedible tissue of the fruit or vegetable and segmenting the separated edible tissue to obtain segmented fruits or vegetables received into the blanching chamber. Preferably, the fruit segmenting apparatus comprises slicing blades for slicing the separated edible tissue into segmented fruits or vegetables.

### BRIEF DESCRIPTION OF DRAWINGS

FIG. 1 is a flow chart of the process in accordance with a first embodiment of the present invention.

FIG. 2A is a top-down view of an apparatus in accordance with a second embodiment of the present invention.

FIG. 2B is a side-elevation view of an apparatus in accordance with the second embodiment of the present invention.

FIG. 2C is an end-elevation view of an apparatus in accordance with the second embodiment of the present invention.

### DESCRIPTION OF EMBODIMENTS

Referring now to the drawings, the process for treating fruits or vegetables in order to minimise browning upon subsequent processing, handling, and storage will be explained in greater detail.

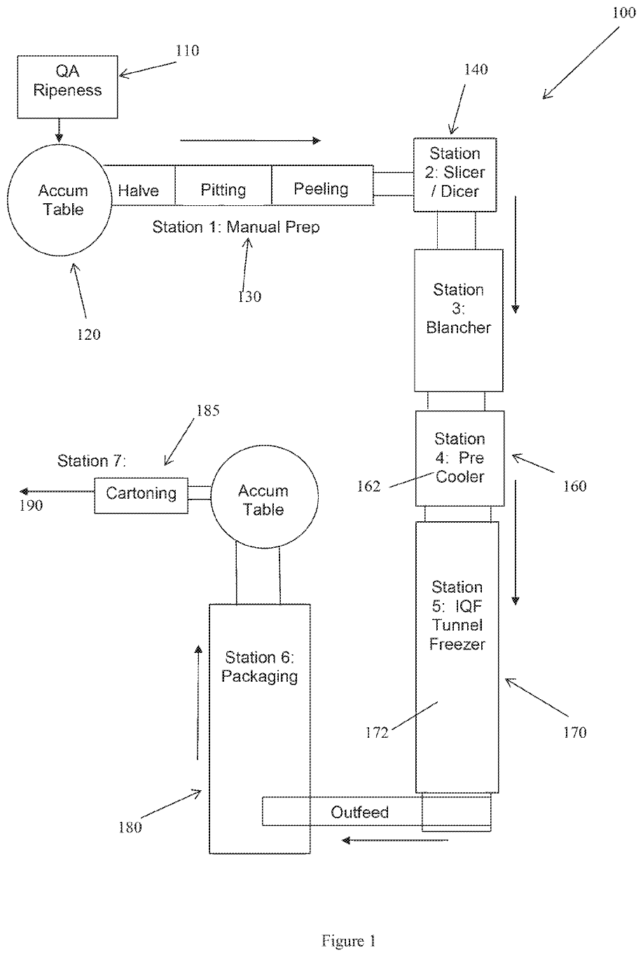

FIG. 1 refers to a flow chart of a process 100 in accordance with an embodiment of the present invention. In a first ripeness assessment step 110, whole avocados are classified by using a penetrometer to classify the avocados on the basis of their ripeness. In one preferred assessment, avocados with a ripeness rating of greater than 70 are selected for the process in accordance with the present invention. The selected fruits are then collected on an accumulation counter in an accumulation step 120. In a subsequent manual handling step 130, each of the fruits is then sliced into half using a slicing implement such as a sharp knife (132) and the pit or the seed is manually removed and discarded from each of the selected fruits (134) and the exocarp/skin is peeled by scooping out the edible/mesocarp of the fruit. The mesocarp is also known as the flesh of the avocado, and this is the edible and most abundant part of the fruit. The edible tissue (which is in two parts-peeled avocado halves) is subsequently transported to a segmenting station 140. The segmenting station 140 comprises a series of rotating blades which slices and/or dices the mesocarp resulting in segmented pieces of the fruit. The segmented pieces are visually inspected at this stage to ensure that the pieces are separate from each other before being undergoing blanching in a blanching step 150.

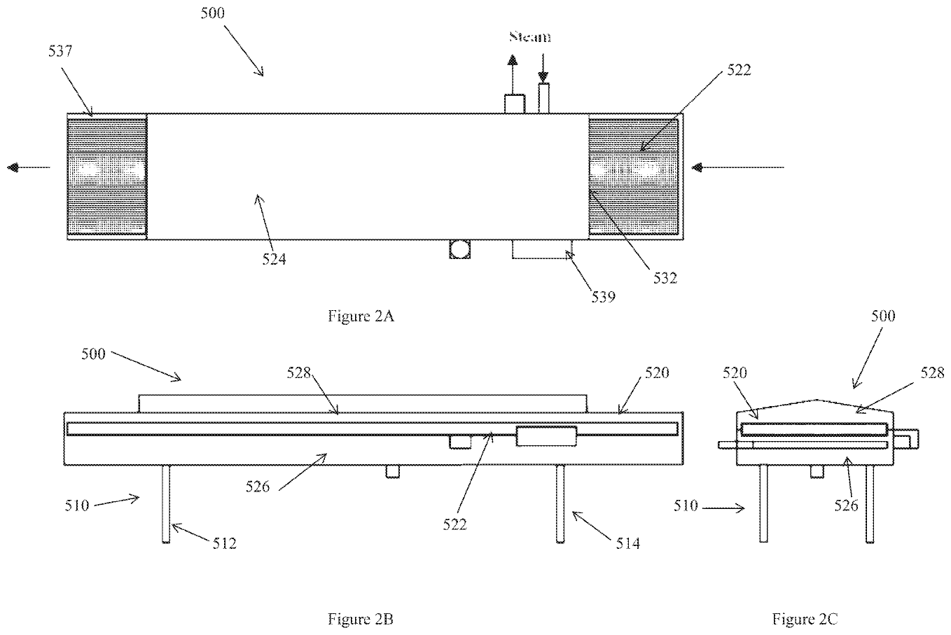

Referring to FIGS. 2A, 2B and 2C, a blancher 500 incorporating the present invention is used for the blanching step 150. The apparatus is mounted on a frame 510 including a plurality of supporting legs 512 and 514 extending vertically. The frames support a conveyor assembly 520 with a conveyor belt in the form of an endless belt 522 supported on rollers (not shown). The frame 510 comprises a shroud in the form of a hood 524 that extends along the longitudinal direction of the endless belt 522 and is positioned to be overlying the endless belt 522. The hood 524 is structurally configured to be in substantial longitudinal alignment with the endless belt 522. An elongate bath 526 for containing water is positioned on underside of the endless belt 522 in substantially longitudinal alignment with the hood 524. The water bath is provided with an inlet means and an outlet means for supplying water and draining water respectively. The hood 524 and the water bath 526 positioned on the override and underside respectively in relation to the endless belt 526 and together define an interior space of a blanching chamber 528. In a typical blanching step 150, the segmented pieces of the fruit from step 140 are positioned on the endless belt 522 at a receiving end 532 of the blancher. A variable speed drive motor 534 is then actuated to drive the endless belt 524 on the rollers. The drive motor 534 is also connected to a control system 536 that controls the speed of the drive motor 534. The control system 536 comprises a sensory mechanism including sensors that are sufficiently adapted to ascertain parameters such as size, weight etc. of the segmented fruit pieces positioned on the endless belt 524. The control system 536 processes the parameters and computes an optimal belt speed for passage of the segmented fruit pieces through the blanching chamber 528 in order to ensure suitable blanching. The control system 536 also controls the belt speed such that the belt speed does not fall below a pre-set minimum belt speed. It is important to appreciate that the total time of exposure of the segmented fruit pieces is directly proportional to the belt speed of the endless belt 524. The time of exposure of the segment fruit pieces to a steam environment is critical to achieving the desired outcome of inhibiting the impact of the ‘browning’ enzyme Polyphenoloxidase (PPO) but not exposing pieces for so long that they tend to ‘cook’. Once the conveyor drive motor 534 is actuated in conjunction with control system 536, the steam control system 540 is also activated. The steam control system heats the water contained in the bath 526 positioned underneath the endless belt 522. As the water in the bath 526 is heated, steam is formed and the steam (water vapour molecules) rises due to the formation of convection currents. As the steam starts rising from the bath it passes through the perforations provided in the endless belt 522. In doing so, the steam contacts the segmented fruit pieces positioned on the belt during the time period (time of exposure/blanching time) of being transported from the receiving end 532 of the blanching chamber 528 to the opposite end of the blanching chamber 528. The positioning of the hood 524 prevents the rapid escape of the steam and allows the steam to accumulate within the blanching chamber 528. It is important to appreciate that the structural configuration of the hood 524, the belt 522 and water bath 528 is such that the pressure in the blanching chamber 528 never exceeds atmospheric pressure. This is achieved by providing a blanching chamber 528 that is not sealed from the atmosphere. Furthermore, the steam used for the blanching process is not pressurised in any manner such by use of nozzles, spraying manifolds etc. before being used for the blanching process of the present invention.

Upon exiting the blanching chamber the blanched fruit pieces are cooled in a cooling step 160. This cooling step should be carried out preferably as soon as possible in order to extract heat from the blanched fruit pieces. In the preferred embodiment of the present invention, the blanched fruit pieces exiting the blanching chamber 528 from the exit end 537 of the blancher 500 on the endless belt 522 are then directed into a cooling station 162. Pre-cooling of the blanched fruit pieces may be carried out by an air chilling mechanism. The air chiller ducts incoming warm moist air surrounding the blanched fruit pieces and releases cooled dry air. The pre-cooling step assists in removing any water that may have inadvertently condensed on the surface of the avocado pieces. The pre-cooling step 160 is introduced prior to a freezing step to lower the heat coefficient and increase freezing efficiency. This is predicated primarily on commercial reasoning to lower the gas usage cost of IQF freezing at the subsequent station.

After the pre-cooling step is conducted, the pre-cooled avocado fruit pieces are transported out of the pre-cooling station 162 and subsequently transported into a freezing station in the form of an Independent Quick Frozen (IQF) tunnel 172 to carry out a freezing step 170. The primary goal of the freezing step 170 is to freeze the avocado pieces as fast as possible in order to minimise water crystallisation of the cut surfaces and produce a final frozen product that comprises substantially similar organoleptic characteristics as that of fresh-cut avocado. To achieve this, Independent Quick Frozen (IQF) freezing technology is used, with carbon dioxide (CO₂) being identified as the preferred refrigerating freezing gas. The endless belt 524 carries the avocado pieces from the pre-cooler station 162 into the IQF freezing tunnel for a pre-determined freezing exposure time. The preferable temperature for freezing the avocado pieces is from −10° F. to −150° F., and more preferably from −70° F. to −120° F. If the temperature is too low, the avocado pieces cannot endure such low temperature and cracks or fissures might be caused. If the temperature is too high, it takes too much time to freeze resulting in an inefficient operation. The extent of exposure of the cooled avocado pieces is determined by the belt speed of the conveyor belt when it is passing the IQF freezing tunnel 172. In one preferred operating configuration, the belt speed of the endless belt 522 may be controlled to be the same as the belt speed used during the blanching step. However, in alternative configurations, the belt speed may be varied using the control system 534. The freezing step must at least be carried out for a sufficient time period that results in formation of at least a ‘crust’ freeze on each of the avocado piece subjected to the freezing step 170. Subsequent internal (core) freezing may be carried out in later steps. Alternatively, the freezing step 170 may also be carried out for a longer time period to ensure complete freezing in the IQF freezing tunnel 172. The requirement of at least carrying out crust freezing limit the extent to which avocado pieces stick to each other, which is an important consideration. Rapid freezing is an important step because fruits such as avocado consist of cells that are filled with water, so that the simple freezing convection (gas or liquid) causes the water to freeze forming ice crystals disrupting the structure and cracking the cell walls of the fruit. By subsequently thawing of the fruit or vegetable that is frozen by simple freezing, the water comes out through the cracked cell walls, leaving a texture that is aesthetically not appealing. The faster the fruit is frozen, smaller the water crystals; thus less disrupting the cell walls, wherewith less liquid is released when thawing.

After the conclusion of freezing step 170, the frozen fruit pieces exit the IQF tunnel 172 on the endless belt 522 and reach a packaging station 180. The packaging step 180 mainly requires the use of suitable packaging such as vacuum seal packaging to prevent the exposure of the frozen fruit pieces to ambient conditions in order to avoid contamination. Any other alternative forms of packaging may also be used in further advantageous embodiments for avoiding contamination. Another important requirement is to limit exposure of the frozen fruit pieces to UV light in order to avoid pigment fading. The sealed fruit pieces may be further packaged into storage containers such as carton boxes in a further packing step 185 before being stored in cold storage in a conventional cold storage facility 190.

The frozen avocados produced by conventional methods easily disintegrate and discolour rapidly at the time of thawing or they are very expensive. However, the frozen avocado pieces produced according to the process of the present invention can preserve their integration, shape and colour for a period of more than 2 weeks after thawing. Moreover, the taste of the avocado pieces thus produced is maintained in a good condition.

### EXAMPLE 1

In accordance with the ripeness assessment step 110 described in earlier sections ripeness assessment of a batch of avocados with a combined weight of 5 kgs was carried out using a penetrometer and all fruits with a ripeness of greater than 70 N were selected. The fruits were subjected to steps 110 to 140 in accordance with the present invention to obtain sliced fruit pieces. Half of the sliced fruit pieces were segregated for the blanching, pre-cooling and freezing steps in accordance with the process of the present invention and the other half was marked as a TEST batch and was left untreated after being sliced into smaller pieces and used a comparative example. Any fruit with exocarp (skin) that had been penetrated, was not selected. The temperature of the core of the fruits was recorded to be in the range of 9-12° C.

At the end of the segmentation step 140, the segmented pieces were visually inspected by personnel and aligned on the endless belt 522 for maximum orientation with dimensions of the endless belt 522. The width and length of the endless belt 522 used in Example 1 were 900 mm and 3.5 m respectively. Blanching was carried in accordance with the blanching step 150 for blanching time period of 3-5 minutes. The belt speed was adjusted using the control system 534 in order to ensure that the segmented avocado pieces passed through the blanching chamber 528 for the time period of 3-5 minutes. After the blanching step, the pre-cooling step 160 was carried out to reduce the temperature of the blanched avocado pieces to a temperature in the range of 20-25° C. After the pre-cooling step, the cooled avocado pieces were subjected to ICQ freezing in the IQF tunnel in accordance with the rapid cooling step 170 for a freezing time period of 5 minutes.

With respect to the shape of the avocado pieces, it was observed that the original shape of each avocado pieces from Example 1 was preserved on and after thawing. In relation to any visually observable colour changes, no significant change was observed until at least ten days with some individual pieces retaining their original colour for as long as 14 days. Thereafter, the surface of the avocado pieces was observed to become gradually blackened due to oxidization.

The taste of the thawed avocado pieces was good enough for eating. Furthermore, long term tests carried out for a 12 month period have also indicated that the pieces retained their colour taste and other desired organoleptic properties once they were thawed after being kept in frozen storage for 12 months.

The frozen avocados from the untreated batch (the comparative example) easily disintegrate and discolour rapidly at the time of thawing. However, the frozen avocado pieces produced according to the present invention can preserve their integration, shape and colour for almost 2 weeks after thawing. Moreover, the taste of the avocado pieces thus produced is maintained in a good condition.

Throughout the specification, the terms “edible tissue”, “pulp tissue” and “pulp” refer to the mesocarp of the fruit which is generally the succulent and fleshy middle layer a fruit located in between the pericarp (the outer skin) and the endocarp (the seed). The mesocarp is usually the major part of the fruit that is eaten, for example, mesocarp makes up most of the edible part of an avocado. Therefore these terms may refer to the fleshy edible regions of any fruit.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. An apparatus for blanching segmented avocados, the apparatus comprising:
a conveyor system for transporting said avocados from one end of a blanching chamber to an opposite end, the conveyor system comprising a perforated conveyor belt positioned on two or more drive rollers for transporting said avocados into and out of the blanching chamber and adapted to be driven by a drive mechanism;
the blanching chamber comprising a shroud overlying the conveyor belt and in longitudinal alignment in relation to the perforated conveyor belt to at least partially enclose steam produced from water in a bath positioned underlying the conveyor belt and in longitudinal alignment with the shroud and the perforated conveyor belt;
wherein during use the steam produced in the bath is at least partially enclosed by the shroud thereby exposing the segmented avocados positioned on the perforated conveyor belt to steam and blanching the avocados in the blanching chamber at a blanching pressure wherein at least a portion of the blanching chamber is not sealed from atmosphere.

2. The apparatus in accordance with claim 1 wherein the perforated conveyor belt is adapted for allowing passage of steam therethrough from an underside in use position of the conveyor belt to the in use avocado supporting surface of the belt.

3. The apparatus in accordance with claim 1 further comprising a control system for varying an in use belt speed of the perforated conveyor belt thereby varying blanching time period of the avocados in the blanching chamber.

4. The apparatus in accordance with claim 3 wherein the control system is adapted to vary the in use belt speed with reference to one or more parameters relating to the segmented avocados positioned on the conveyor belt during use.

5. The apparatus in accordance with claim 3 wherein the control system is adapted to prevent the in use belt speed from being below a pre- determined value of belt speed.

6. The apparatus in accordance with claim 1 further comprising a steam control mechanism for controlling steam volume and/or steam temperature during use.

7. A system for processing segmented avocados upon, the system comprising the apparatus for blanching in accordance with claim 1 for minimizing browning of the segmented avocados, a cooling apparatus positioned for receiving and extracting heat from the blanched avocados and a freezing apparatus for receiving the cooled avocados and at least partially freezing the segmented avocados.

8. The system in accordance with claim 7 wherein the conveyor system transports blanched avocados to the cooling apparatus and subsequent to the extraction of heat transports the cooled avocados to the freezing apparatus.

9. The system in accordance with claim 7 further comprising a avocado segmenting apparatus for separating mesocarp from the pericarp and endocarp of the avocado and segmenting the separated mesocarp to obtain segmented avocados received into the blanching chamber.

10. The system in accordance with claim 9 wherein the avocado segmenting apparatus comprises slicing blades for slicing the separated edible pulp tissue into segmented avocados.
